(19) United States
(12) Patent Application Publication
(10) Pub. No.: US 2009/0315266 A1
(43) Pub. Date: Dec. 24, 2009

(54) Extrusion-Resistant Nose Seal

(75) Inventors: Samir M. Nazir, Houston, TX (US); Walter J. Myron, Houston, TX (US); Conrad G. Weinig, Missouri City, TX (US)

Correspondence Address: SHAWN HUNTER, P.O Box 270110, HOUSTON, TX, 77277-0110, US

(73) Assignee: Baker Hughes Incorporated, Houston, TX (US)

(21) Appl. No.: 12/141,965

(22) Filed: Jun. 19, 2008

(51) Int. Cl. F16J 15/32; F16L 17/00; F16J 9/12

(52) U.S. Cl. 277/309; 277/626; 277/434

(57) ABSTRACT

A nose seal for forming a fluid seal with a sealing surface in a bore The nose seal is particularly suitable for use in high pressure and high temperature conditions. The nose seal includes a substantially deformable sealing ring, which can form a resilient fluid seal with the sealing surface, and a substantially rigid ring, which prevents or limits extrusion of the substantially deformable sealing ring in high temperature and/or high pressure environments.

### BACKGROUND OF THE INVENTION

1. Field of the Invention

The invention relates to devices and methods for forming a fluid seal within a bore between radially inner and outer members. In particular aspects, the invention relates to the design of a nose seal which creates a resilient and robust seal against a substantially conical, inwardly-directed surface in a bore.

2. Description of the Related Art

A number of tools and devices that are used within a hydrocarbon production wellbore feature radially inner and outer members that are slidable with respect to one another. Examples include piston assemblies and sliding sleeve valves. Annular elastomeric o-ring seals are commonly used to create a fluid seal between the radially inner member and that outer member.

### SUMMARY OF THE INVENTION

The present invention generally provides a nose seal for forming a fluid seal within a bore between radially inner and outer members and, in particular aspects, forming a seal against a substantially conical, inwardly-directed sealing surface in the bore. The nose seal is particularly suitable for use in high pressure and high temperature conditions. In a preferred embodiment, the nose seal includes a deformable sealing ring, which can form a resilient fluid seal with the sealing surface, and a substantially rigid, non-deformable sealing ring, which prevents or limits extrusion of the flexible sealing ring in high temperature and/or high pressure environments.

### BRIEF DESCRIPTION OF THE DRAWINGS

The structure and operation of the invention will be more readily understood with reference to the following drawings, which are illustrative thereof and among which like components are numbered with like reference numerals:

FIG. 1 is a side, cross-sectional view of an exemplary piston portion of a stepper valve, containing a nose seal constructed in accordance with the present invention.

FIG. 2 is an isometric view of an exemplary nose seal constructed in accordance with the present invention.

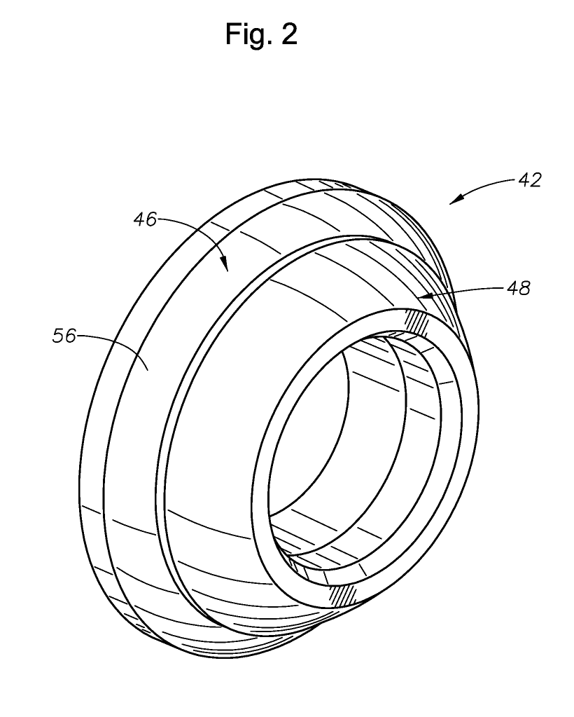

FIG. 3 is an enlarged cross-sectional view of the nose portion of the piston member within the piston portion shown in FIG. 1.

FIG. 4 is an enlarged cross-sectional view of the nose portion now in sealing contact with the surrounding bore.

### DETAILED DESCRIPTION OF THE PREFERRED EMBODIMENTS

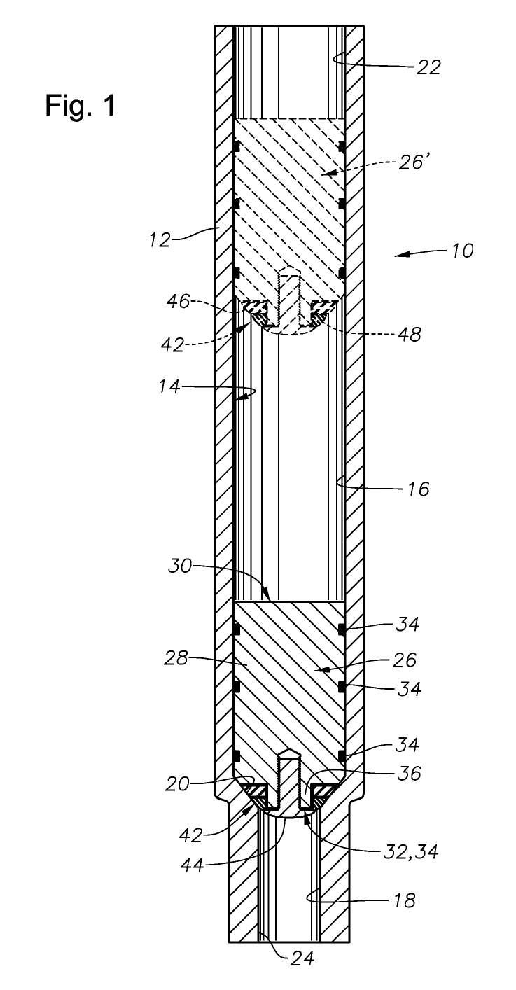

FIG. 1 depicts an exemplary piston assembly 10. In one embodiment, the piston assembly 10 is a piston assembly incorporated within a “stepper” type metering valve of the type used to meter discrete increments of fluid, including both liquid and gaseous fluids, into or out of a hydraulically-operated well tool. One such stepper valve is the HCM-S series stepper valve which is available commercially from Baker Oil tools of Houston, Tex. The piston assembly 10 includes a tubular housing 12 which defines a longitudinal axial bore 14. The bore 14 includes an upper, enlarged-diameter portion 16 and a lower, reduced-diameter portion 18. A conically-shaped inwardly-directed sealing surface 20 is formed between the upper and lower portions 16, 18. The bore 14 is provided with a fluid inlet 22 and a fluid outlet 24.

A piston member 26 is moveably disposed with respect to the housing 12 within the upper portion 16 of the bore 14. The piston member 26 is moveable between the lower position within the upper bore portion 16, shown in FIG. 1, and an upper position within the upper bore portion 16, which is depicted in phantom lines at 26′ in FIG. 1. The piston member 26 includes a piston body 28 having an upstream axial end 30 and a downstream axial end 32. Annular o-ring fluid seals 34, of a type well known in the art, radially surround the body 28 and contact the upper bore portion 16 to provide fluid sealing between the body 28 and the bore 14. In operation, the piston member 26 is moved axially along the upper bore portion 16 by pressure increases and decreases which act upon the upstream end 30 of the piston member 26.

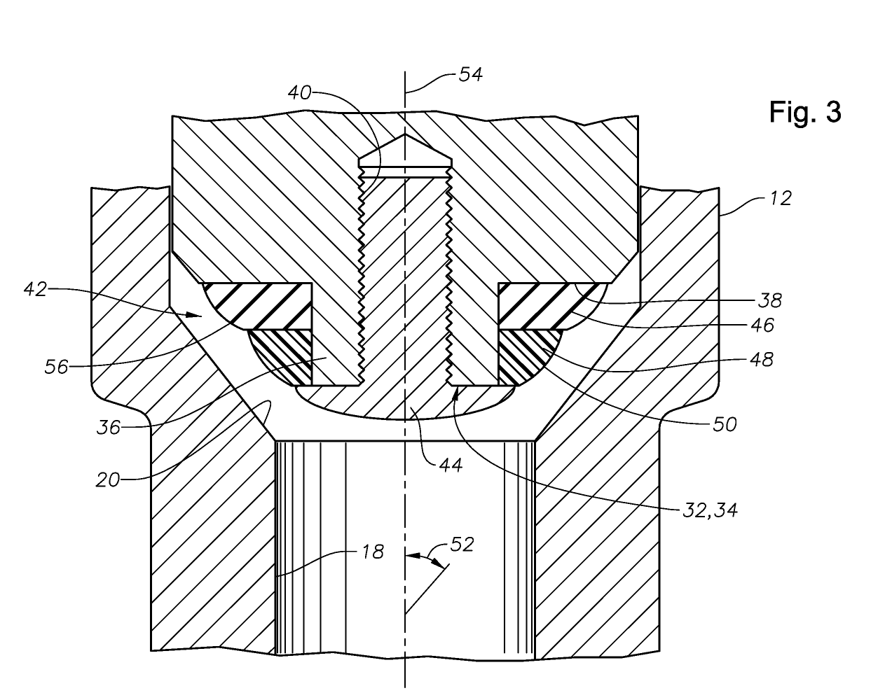

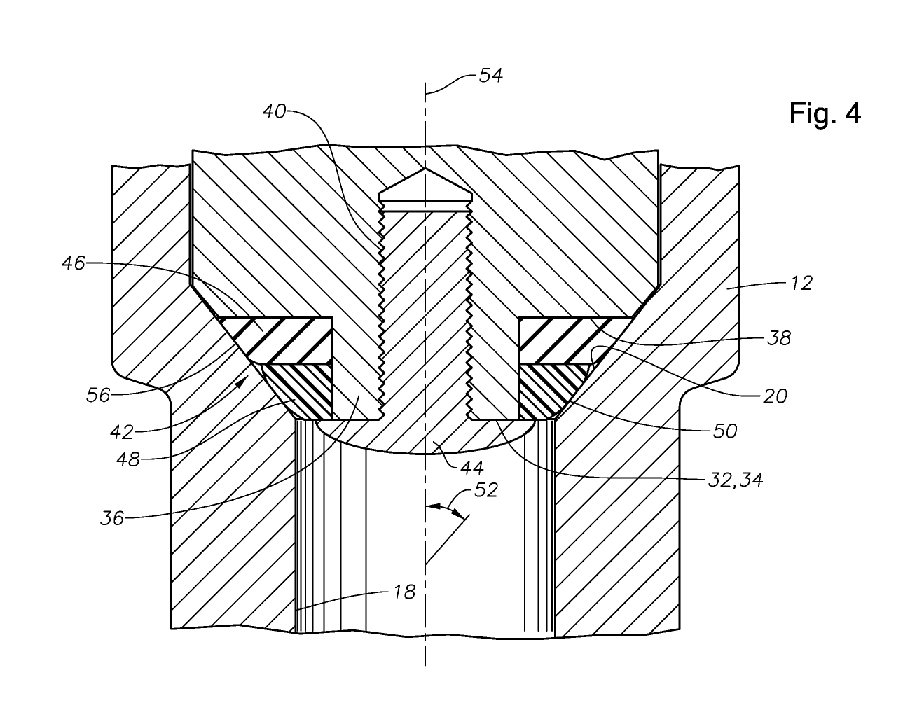

The downstream end 32 of the piston member 26 is shown in greater detail in FIGS. 3 and 4. The downstream end 32 presents a nose portion 34 in which a reduced diameter post 36 extends axially from the body 28. The nose portion 34 is the portion of the piston member 26 that will form a seal with the sealing surface 20 of the bore 14. An annular, axially-facing shoulder 38 surrounds the post 36. A threaded bore 40 is disposed into the post 36.

An exemplary nose seal, generally indicated at 42, is disposed radially around the post 36 and upon the shoulder 38. A connector, such as screw 44, is then threaded into the bore 40 to secure the nose seal 42 to the downstream end 32 of the piston member 26. The nose seal 42 includes a substantially deformable sealing ring 46 and a substantially rigid, non-deformable ring 48. The substantially rigid ring 48 is relatively harder than the deformable ring 46. The deformable ring 46 has a larger outer diameter than the rigid ring 48. It is currently preferred that the two rings 46, 48 abut one another. In preferred embodiments, the deformable sealing ring 46 is formed of a readily deformable material such as PTFE (polytetrafluoroethylene). However, other suitable materials may be used. Also in preferred embodiments, the rigid ring 48 is formed of a harder, substantially non-deformable material, such as PEEK (polyetheretherketone). However, other suitable materials may be used. In a preferred embodiment, the rigid ring 48 presents a generally triangular cross-section, as can be seen best in FIGS. 3 and 4, with the radially outer surface 50 of the rigid ring 48 forming an acute angle 52 with the axis 54 of the bore 14. It is preferred that the angle 52 approximate the angle at which the sealing surface 20 of the bore 14 is disposed. In addition, as can be seen from FIG. 3, the outer radial surfaces 50, 56 of the rings 46, 48 preferably bow convexly outwardly.

The nose seal 42 functions to form a resilient fluid seal with the surrounding bore 14 of the housing 12. FIG. 3 illustrates the piston member 26 in a position wherein the nose seal 42 is not sealed against the sealing surface 20. FIG. 4 depicts the piston member 26 now in a position wherein it is at its furthest downward position within the bore 14 and in sealing contact with the sealing surface 20 of the bore 14. As illustrates, the outer radial surface 56 of the flexible sealing ring 46 is pressed against the surrounding sealing surface 20 and forms a fluid seal therewith. This resilient seal will form at relatively low pressures and/or temperatures. In addition, the outer radial surface 50 of the rigid ring 48 is urged against the sealing surface 20. As pressure increases at the upstream axial end 30 of the piston member 26, the nose seal 42 will be urged more tightly against the sealing surface 20. In addition, pressurized fluid may bypass the annular seals 34 of the piston body 28 to act piston body 28 to act upon the flexible seal ring 46. The rigid ring 48 will block extrusion of the flexible seal ring 46 past the sealing surface 20 and downwardly toward the lower bore portion 18.

Although the nose seal 42 has been described herein used with a piston assembly, it may be applied for use in other moveable piston-type devices which incorporate a bore which presents a sealing surface and a moveable member that is slidably disposed within the bore. One example is a sliding sleeve valve or device. These devices will be referred to generally in the claims as a “moveable piston” device. Those of skill in the art will recognize that numerous modifications and changes may be made to the exemplary designs and embodiments described herein and that the invention is limited only by the claims that follow and any equivalents thereof.

What is claimed is:

1. A nose seal for forming a fluid seal with a sealing surface within a bore, the nose seal comprising:
a substantially deformable member for forming a resilient fluid seal against the sealing surface; and
a substantially rigid member to prevent extrusion of the substantially non-deformable member within the bore.

2. The nose seal of claim 1 wherein the substantially deformable member is substantially formed of a polymer material.

3. The nose seal of claim 2 wherein the polymer material comprises polytetrafluoroethylene.

4. The nose seal of claim 1 wherein the substantially rigid member is substantially formed of a polymer material.

5. The nose seal of claim 4 wherein the polymer material comprises polyetheretherketone.

6. The nose seal of claim 1 wherein the substantially flexible member and the substantially rigid member are both annular rings.

7. The nose seal of claim 6 wherein the substantially rigid ring presents a generally triangular cross-section.

8. A moveable piston device comprising:
a housing defining an axial bore which presents a sealing surface;
a piston member moveably disposed within the bore and having a nose portion for contacting and sealing against the sealing surface, the nose portion comprising a nose seal comprising:
a substantially deformable ring to contact and create a seal against the sealing surface; and
a substantially rigid ring to contact the sealing surface and block extrusion of the substantially flexible ring past the sealing surface;
the piston member further being moveable between a position wherein the piston member does not contact the sealing surface and a position wherein the piston member does contact the sealing surface.

9. The moveable piston device of claim 8 wherein the substantially deformable member is substantially formed of a polymer material.

10. The moveable piston device of claim 9 wherein the polymer material forming the substantially deformable member comprises polytetrafluoroethylene.

11. The moveable piston device of claim 8 wherein the substantially rigid member is substantially formed of a polymer material.

12. The moveable piston device of claim 11 wherein the polymer material forming the substantially rigid member comprises polyetheretherketone.

13. The moveable piston device of claim 8 wherein the substantially flexible ring and the substantially rigid ring are secured to the piston member by a threaded connector.

14. A method of forming a fluid seal between a sealing surface in a bore and a piston member within the bore comprising the steps of:
affixing a nose seal to a nose portion of the piston member, the nose seal having a substantially flexible ring for creating a fluid seal against the sealing surface and a substantially rigid ring for contacting the sealing surface;
contacting the sealing surface with the nose portion so that the substantially deformable ring forms a fluid seal against the sealing surface; and
blocking extrusion of the substantially deformable ring with the substantially rigid ring.
